(19) United States
(12) Patent Application Publication
(10) Pub. No.: US 2023/0075450 A1
(43) Pub. Date: Mar. 9, 2023

(54) Customized Payment Card and a Method for Generating the Customized Payment Card

(71) Applicant: Cheryl Hayes, Baraboo, WI (US)

(72) Inventor: Cheryl Hayes, Baraboo, WI (US)

(21) Appl. No.: 17/708,731

(22) Filed: Mar. 30, 2022

Related U.S. Application Data
(60) Provisional application No. 63/241,690, filed on Sep. 8, 2021.

(51) Int. Cl. G06Q 20/34; G06Q 20/32

(52) U.S. Cl. CPC G06Q 20/3552; G06Q 20/351; G06Q 20/349; G06Q 20/3255

(57) ABSTRACT

The present invention relates to a multifunctional payment card configured to be used for a variety of purposes wherein money can be easily transferred from any credit card, debit card, and/or bank account onto the card. Money spent using the card can be tracked using a card ordering software application and money can be added/transferred to the card or removed from the card. A card generation system generates the payment card and a user may use the card ordering software application for ordering and customizing the card. The card can be used as a gift card and prepaid card. The card is provided both as a physical card and a digital card.

### CROSS-REFERENCE TO RELATED APPLICATION

The present application claims priority to, and the benefit of, U.S. Provisional Application No. 63/241,690, which was filed on Sep. 8, 2021 and is incorporated herein by reference in its entirety.

### FIELD OF THE INVENTION

The present invention relates generally to the field of gift cards. More specifically, the present invention relates to a customized and personalized financial card and a system and method for generating the financial card. The card enables a user to gift money via the card as well as the ability to monitor the spending and transactions of the card. The card comes in various designs and colors for offering customized cards and enable users to transfer money between different cards and accounts for payment purposes. Accordingly, the present disclosure makes specific reference thereto. Nonetheless, it is to be appreciated that aspects of the present invention are also equally applicable to other like applications, devices, and methods of manufacture.

### BACKGROUND

Traditionally, individuals use a plurality of financial cards like credit cards, debit cards, and other bank accounts for performing transactions. For example, a user decides to use one of the many cards for performing a transaction with a merchant. Managing money through one or multiple bank/savings accounts can be exceptionally frustrating for individuals. Individuals may forget to repay the money spent on the credit card which can incur penalties and force individuals to repay more money than they spent. Further, teens and even adults may end up spending excessive money using these cards which can be detrimental to their financial planning. Individuals desire a card that can be used for performing transactions and which can receive money from any conventional card and account so that individuals may use only a single card for performing transactions.

Individuals also use stored value cards or gift cards based upon their intended use. Gift cards typically comprise a stored value card whereby a certain cash equivalent value is encoded upon a magnetic strip applied to the surface of the card. However, a problem with such cards is that purchaser of the card or the person who generated the card cannot track the expenditure on the card. Individuals desire a unique card which can be tracked by the purchaser of the card as this can be especially useful where a parent issues or gifts the card to their children and they want to track the ensuing expenditures.

In conventional cards, the amount that is associated with a card cannot be removed as per the desire of the purchaser of the card. This problem is exacerbated when the card is stolen and a user has to disable the card. Individuals desire a card that enables a user to remove the balance/cash associated with the card.

Individuals may have credit cards, debit cards, and other gift cards but lack a multipurpose card that is suited as a gift card and/or prepaid card that can be used for monitoring and tracking transactions.

Therefore, there exists a long-felt need in the art for a multifunctional card that enables users to easily add money/funds to the card and remove money from the card. There is also a long-felt need in the art for a system that easily generates customized cards tailored to a user's preferences. Additionally, there is a long-felt need in the art for a financial card that can be used as a credit card, gift card, and debit card. Moreover, there is a long-felt need in the art for a financial card that enables users to easily track money spent using the card. Further, there is a long-felt need in the art for a system and method that enables individuals to purchase a card for gifting to other users. Furthermore, there is a long-felt need in the art for a card that enables users to transfer money between different cards and accounts for payment purposes. Finally, there is a long-felt need in the art for a payment card that is a personalized card that can be used for a variety of transactions.

The subject matter disclosed and claimed herein, in one embodiment thereof, comprises a multifunctional and personalized payment card. The multifunctional payment card includes a front surface and a rear surface, the front surface includes a customized color and design, name of an intended user of the card, customized or selectable message for the user of the card, a monetary amount associated with the card and a computer readable chip whereby the monetary amount equivalent value is encoded in the chip. The rear surface includes a magnetic strip whereby a certain cash equivalent value is encoded upon the magnetic strip applied to the rear surface of the card. The card is generated and customized via an online and interactive card ordering platform, whereby a user may provide content for customization for inclusion in the production of the card and can track money spent on the card.

In this manner, the payment card of the present invention accomplishes all of the forgoing objectives and provides users with an improved debit or credit card with several features designed to enhance transaction tracking, transferring money to different accounts, and more. The card enables a user to track spending on the card. The card comes in a variety of colors, styles, and designs.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method for creating a personalized multifunctional payment card. The payment card is designed to enhance transaction tracking, transferring money from different credit cards, debit cards and accounts. The method further comprising the steps of receiving, at a server from a customer, multifunctional payment card recipient information; receiving, at the server from the customer, an amount value to be stored in the multifunctional payment card; receiving, at the server from the customer, a selection of one of a credit card, debit card or a bank account to credit the amount of value on the multifunctional payment card; generating, by the server, a digital multifunctional payment card and a physical multifunctional payment card, the digital multifunctional payment card includes a card number and associated password for use for performing a transaction and the physical card includes a machine readable code for performing a transaction. The recipient information received from the customer includes at least recipient name, recipient email ID, and recipient mailing address wherein the digital multifunctional payment card is sent to the recipient email ID and the physical multifunctional payment card is delivered to the recipient mailing address.

In yet another embodiment of the present invention, a multifunctional and personalized payment card is disclosed. The multifunctional payment card includes a front surface and a rear surface, the front surface includes a customized color and design, name of an intended user of the card, customized or selectable message for the user of the card, a monetary amount associated with the card and a computer readable chip whereby the monetary amount equivalent value is encoded in the chip. The rear surface includes a magnetic strip whereby a certain cash equivalent value is encoded upon the magnetic strip applied to the rear surface of the card. The card is generated and customized via an online and interactive card ordering platform, whereby a user may provide content for customization for inclusion in the production of the card and can track money spent on the card.

In yet another embodiment, the card includes a photo of the intended user of the card, and the card can be used only once. In yet another embodiment, the card can be used multiple times within a predetermined time period.

In yet another embodiment of the present invention, a method for tracking expenditure on multifunctional and personalized payment card is disclosed. The method includes the steps of associating, by a computer based server, a cash value equivalent with the card wherein the cash value equivalent is selected by a user using a graphical user interface programmed by the server; purchasing the card by a user for a recipient and the card is physically delivered to the recipient, receiving, by the computer-based server, transaction information performed using the card; transmitting, by the computer based server, a notification to the user, the notification including balance cash equivalent associated with the card.

In yet another embodiment of the present invention, a method of associating and removing cash equivalent to a gift card is disclosed. The method includes receiving, from a first user, a request to select a gift card for a second user; receiving, from the first user, attributes of the second user for customizing the gift card; receiving, from the first user, a cash equivalent amount to be associated with the gift card that the second user can use for performing a transaction wherein the cash equivalent is deducted from one of a credit card, debit card or a bank account selected by the first user, generating the gift card having the associated cash equivalent value and receiving, from the first user, a request to remove the cash equivalent value associated with the card.

In yet another embodiment, the method further comprising deducting, two percent of the cash equivalent associated with the card as a convenience fee.

In yet another embodiment, the method further comprising sending, to the first user, a notification including remaining cash equivalent associated with the card.

In some embodiments, once the payment or gift card is selected and purchased, the card can be sent or communicated to the intended recipient from the computer server via a network. In some embodiments, the gift card can be sent to the recipient in the form of a uniquely identified token attached to or as part of a text, email, or in any other electronic form. In other embodiments the user can be able to request a physical gift card and the card can be mailed to a delivery address of the recipient.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of multipurpose financial card generating system for generating a customized multipurpose financial card of the present invention in accordance with the disclosed architecture;

FIG. 2A illustrates a front perspective view of one potential embodiment of the financial card of the present invention in accordance with the disclosed architecture;

FIG. 2B illustrates a rear perspective view of the financial card of the present invention in accordance with the disclosed architecture;

FIG. 3A illustrates an exemplary graphical user interface provided by the software application for generating the financial card in accordance with the disclosed architecture;

FIG. 3B illustrates an exemplary user interface providing additional parameters for customization and preview of the financial card in accordance with the disclosed architecture;

FIG. 3C illustrates another user interface showing exemplary payment methods for adding money to the financial card in accordance with the disclosed architecture;

FIG. 3D illustrates an occasion specific card selection user interface provided by the card ordering application of the present invention in accordance with the disclosed architecture;

FIG. 4 illustrates a flow diagram depicting a process of adding money to a physical financial card purchased from any location in accordance with the disclosed architecture;

FIG. 5 illustrates a flow diagram depicting a process of generating a financial card and removing cash equivalent from the financial card in accordance with the disclosed architecture;

FIG. 6 illustrates a flow diagram depicting a process of sending low balance notifications to the user who purchased the financial card in accordance with the disclosed architecture;

FIG. 7 illustrates the components of the server used in the present invention of the present invention in accordance with the disclosed architecture; and

FIG. 8 illustrates an exemplary computing device in which the financial card ordering application of the present disclosure is installed in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there exists a long-felt need in the art for a multifunctional card that enables users to easily add money/funds to the card and remove money from the card. There is also a long-felt need in the art for a system that easily generates customized cards tailored to a user's preferences. Additionally, there is a long-felt need in the art for a financial card that can be used as a credit card, gift card, and debit card. Moreover, there is a long-felt need in the art for a financial card that enables users to easily track money spent using the card. Further, there is a long felt need in the art for a system and method that enables individuals or transferors to purchase cards for gifting to other users. Furthermore, there is a long-felt need in the art for a card that enables users to transfer money between different cards and accounts for payment purposes. Finally, there is a long-felt need in the art for a payment card that is a personalized card that can be used for a variety of transactions.

The present invention, in one exemplary embodiment, is a method for creating a personalized multifunctional payment card. The method further comprising the steps of receiving, at a server from a customer, multifunctional payment card recipient information; receiving, at the server from the customer, an amount value to be stored in the multifunctional payment card; receiving, at the server from the customer, a selection of one of a credit card, debit card, or a bank account to credit the amount value in the multifunctional payment card; generating, by the server, a digital multifunctional payment card and a physical multifunctional payment card, the digital multifunctional payment card includes a card number and associated password for use for performing a transaction; and, wherein the physical card includes a machine readable code for performing a transaction. The recipient information received from the customer includes at least recipient name, recipient email ID, and recipient mailing address, wherein the digital multifunctional payment card is sent to the recipient email ID and the physical multifunctional payment card is delivered to the recipient mailing address.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “electronic device or computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

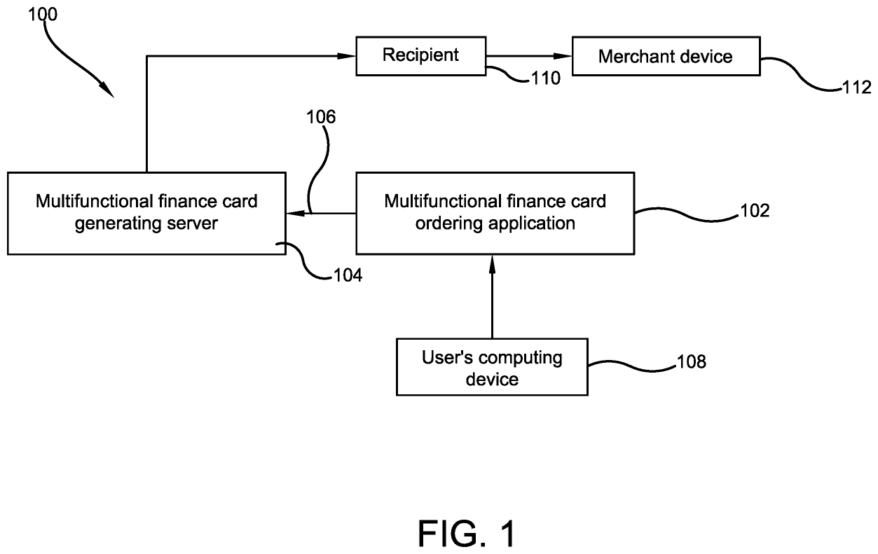

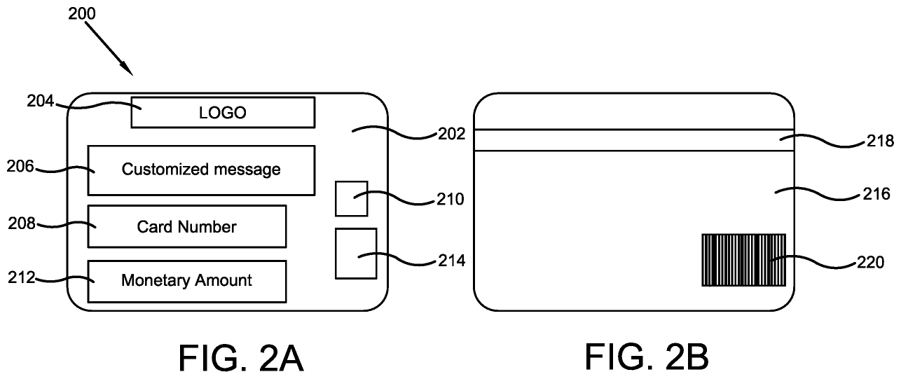

Referring initially to the drawings, FIG. 1 illustrates a schematic view of a multipurpose financial card generating system for generating a customized multipurpose financial card of the present invention in accordance with the disclosed architecture. The multipurpose financial card generating system 100 of the present invention is designed for users to generate a multipurpose financial or gift card 200 (shown in FIG. 2) and provides the ability to monitor the spending and transactions on the card 200 using a multifunctional finance card ordering application 102. The system 100 also enables users to transfer money onto the card 200 from existing credit cards, debit cards and bank accounts using the software application 102. Additionally, a purchasing user (i.e. transferor) can remove associated money or cash equivalent from the card 200 using the software application 102.

More specifically, the system 100 includes a multifunctional finance card generating server 104 that is connected to the multifunctional finance card ordering application 102 through a network 106 such as Internet. In particular, various embodiments of the invention discussed herein are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links can be utilized.

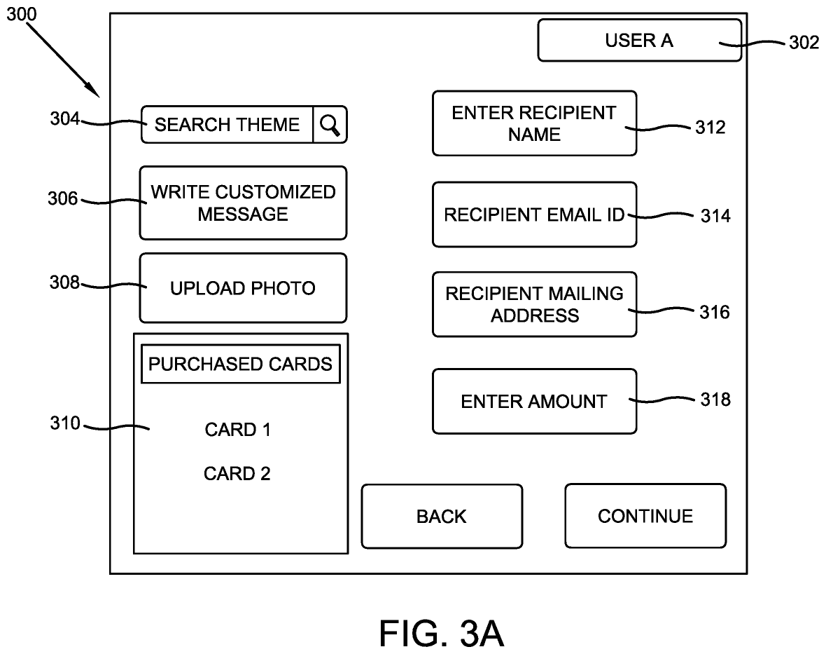

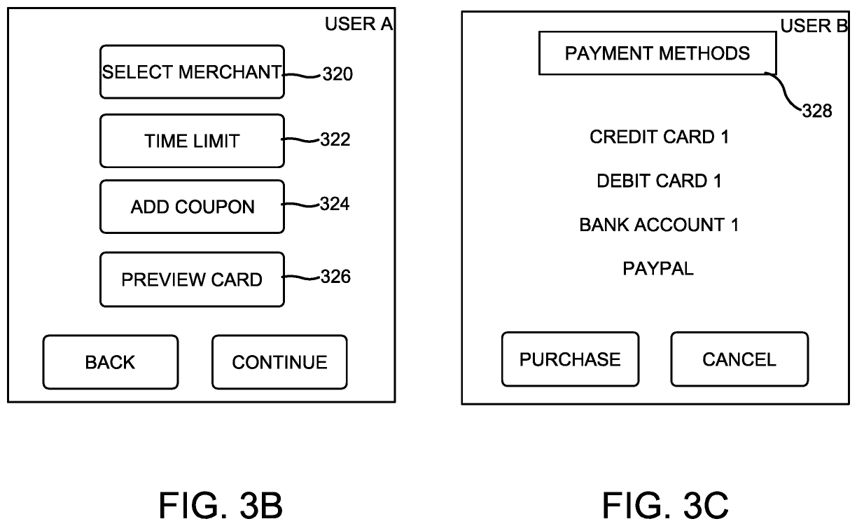

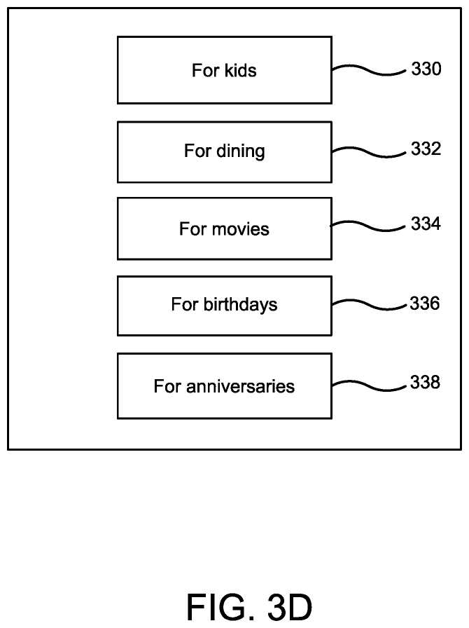

The multifunctional finance card ordering application 102 is configured to provide graphical user interface (GUI) to a computing device 108 of a purchasing user (i.e. transferor) for requesting to generate at least one multipurpose and customized financial card 200. Exemplary GUIs provided by the application 102 to a purchasing user are described in FIGS. 3A, 3B, 3C, and 3D. The server 104 is configured to execute the application 102 and provide GUIs to a purchasing user. The server 104 is also configured to generate the financial card 200 and mail the physical financial card to a recipient (i.e. transferee) specified by the purchasing user or transferor.

Using the system, the cards are purchased by a user using a computing device 108 such as a smartphone, tablet, or any other electronic device. Alternatively, the user can purchase a physical card from a location such as a store, bank, or any other location and money/funds can be added or transferred to the physical card using the software application 102 accessing on the computing device 108. The physical cards can be available in a variety of colors and designs and can come in a pack of cards (i.e. five or ten cards). Each card can be individually associated with a cash equivalent using the software application 102. As an example, a parent can purchase a physical card and add or transfer money/funds to the card using the application 102. The card then can be used by a child for payments in lieu of cash, and the parent can monitor the expenditures on the card.

The recipient 110 can use the financial card 200 for a transaction with one or more merchants where the merchant can be any online merchant or a brick-and-mortar merchant device 112. It should be appreciated that the purchasing user and the recipient can be the same when the user purchases the card 200 for personal use. In addition to mailing a physical card to the recipient 110, a digital card can also be sent as an email ID, SMS, or MMS to a messaging service specified by the purchasing user for instant use. The physical card can be sent to the recipient using a suitable mail delivery service.

FIG. 2A illustrates a front perspective view of one potential embodiment of the financial card 200 of the present invention in accordance with the disclosed architecture. The front surface 202 of the card 200 includes a theme-based design. The design is either selected by a user purchasing the card 200 on the GUI of the application 102 as shown in FIG. 3A or can be automatically selected by the application 102 as described in FIG. 3D. The front surface 202 can include a selectable Logo, Trademark, or any other indicia 204 for depicting the card issuer company. A customized or selectable message 206 for an intended user of the card 200 is positioned on the front surface 202 and the customized or selectable message 206 can be a greeting message such as “Congratulations”, “Happy Birthday”, “Enjoy” and/or “God Bless”, and more, and can be selected by a user (i.e. transferor) purchasing the card as shown in FIG. 3A.

A random issued card number 208 is embossed on the front surface 202 and the card number 208 is provided or issued by the server 104 and serves as a unique identifier for the card 200. A machine-readable smart chip 210 is disposed on the front surface 202 that contains a cash equivalent of the amount stored in the card 200. The chip 210 can be readable by a point of sale (POS) machine, an ATM machine, and other card readers to deduct an amount from the card 200. The cash equivalent value 212 is also embossed on the front surface 202. A photo 214 of the intended user is also optionally adhered to the front surface 202 for providing customization to the card 200.

FIG. 2B illustrates a rear perspective view of the financial card 200 of the present invention in accordance with the disclosed architecture. As shown, the rear surface 216 includes a computer readable magnetic strip 218 that contains a cash equivalent of the monetary value associated with the card 200. The magnetic strip 218 is configured to be readable by a conventional card reader for performing a transaction. The rear surface 216 may also have a barcode 220 that functions similar to the magnetic strip 218.

FIG. 3A illustrates an exemplary graphical user interface provided by the software application 102 for generating and transacting the financial card 200 in accordance with the disclosed architecture. A purchasing user accesses the exemplary interface 300 on an electronic device. The interface 300 can also be provided by the server 104 through a website which can be accessed on a web browser. The interface 300 corresponds to the logged in purchasing user “USER A” 302. For generating a customized card, a theme search bar 304 is provided that can be used for selecting a specific theme and design for the card. A customized or selectable message to be embossed or printed on the front surface of the card is written by the purchasing user in the tab 306. The upload photo tab 308 enables the user to upload a photo that can be adhered on the front surface of the card 200 as shown in FIG. 2. The purchased cards section 310 displays a list of financial cards already purchased by the user 302. The cards are selectable on the electronic device and can be clicked to view the details of each individual card.

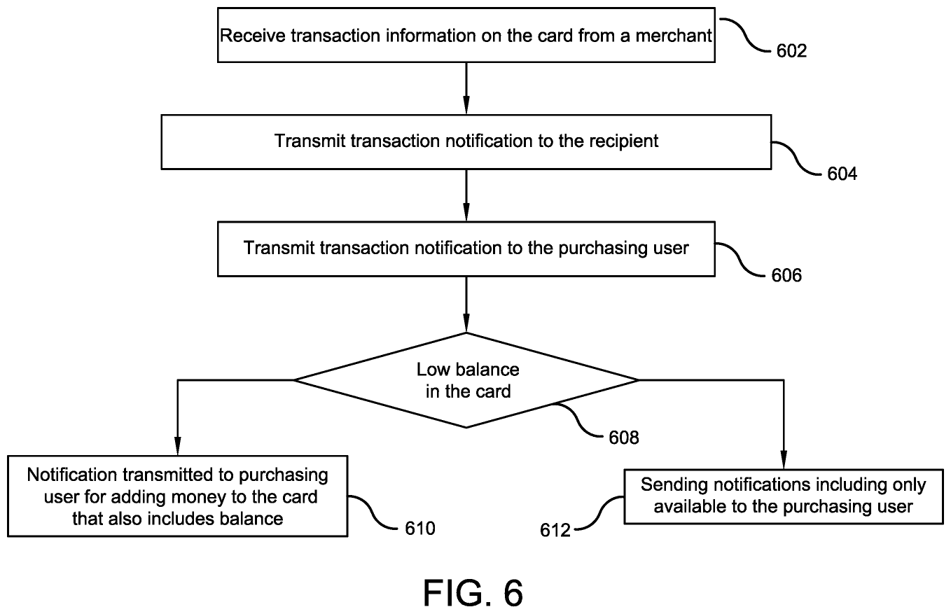

The card generated by the system of the present invention is associated with a recipient and can be used as a prepaid, gift, emergency, cash, and/or debit card by the recipient. The purchasing user 302 selects a recipient name 312, recipient email ID 314, and recipient mailing address 316 for a recipient of the card. It should be understood that the purchasing user can purchase the card for himself/herself and can also associate a physical card purchased from a store (as described in FIG. 6) with a recipient. The physical card when generated by the server 104 on the request of the purchasing user, is mailed to the recipient mailing address 316 and a digital copy of the card is sent to the recipient email ID 314. When the physical card is purchased by the user and is merely activated using the software application, then, the physical card is not mailed to the address but only the digital card is sent to the email ID.

An “Enter amount” tab 318 is used for associating an amount or cash equivalent with the card. A payment method can be selected for adding money to the card as shown in FIG. 3B. The user can go back or continue with the process as per the preference of the user.

FIG. 3B illustrates an exemplary user interface providing additional parameters for customization, transacting, and purview of the financial card 200 in accordance with the disclosed architecture. As shown, the “Select merchant” tab 320 enables the user to select a merchant for associating the card. If a merchant is selected, the card 200 can be specifically used for a transaction at that merchant. This is useful for the parents to issue a card for their children to perform transactions at a specific merchant. The card may provide discounts or cashback upon using the card at the specified merchant. An optional feature “Time Limit” 322 can be selected for associating a time limit or duration with the card where the card can be used for performing a transaction within a selected time limit only.

For purchasing the card by the user, a discount coupon can be added using the “Add discount” tab 324. Once, the parameters are selected by the user, a “Preview card” tab 326 can be selected for previewing the card by the user. The previewed card, once approved by the user, is selected for generation.

FIG. 3C illustrates another user interface showing exemplary payment methods for adding money to the financial card in accordance with the disclosed architecture. The purchasing user “USER A” can store a plurality of credit cards, debit cards, and bank accounts in the payment methods 328 for transferring money to the financial card to be purchased by the user. New payment methods including new cards and bank accounts can also be added by the user for transferring money to the card. The server of the system of the present invention can deduct a convenience fee while transferring amounts/funds to the card. The convenience fee may range from about 2% to about 5% of the amount transferred to the card.

FIG. 3D illustrates an occasion-specific card selection user interface provided by the card ordering application of the present invention in accordance with the disclosed architecture. As shown, the application 102 offers a “For kids” tab 330 for providing a kids themed financial card 200. The card 200 may have cartoons or animated characters. “For dining” tab 332 provides cards themed for dining occasions and can be selected by a user for gifting to another user for dining purposes. Similarly, the application 202 offers movie specific 334, birthday specific 336, and anniversary specific 338 financial cards. It should be noted that the categories are exemplary and any new category can be added as per the requirement and preferences of users.

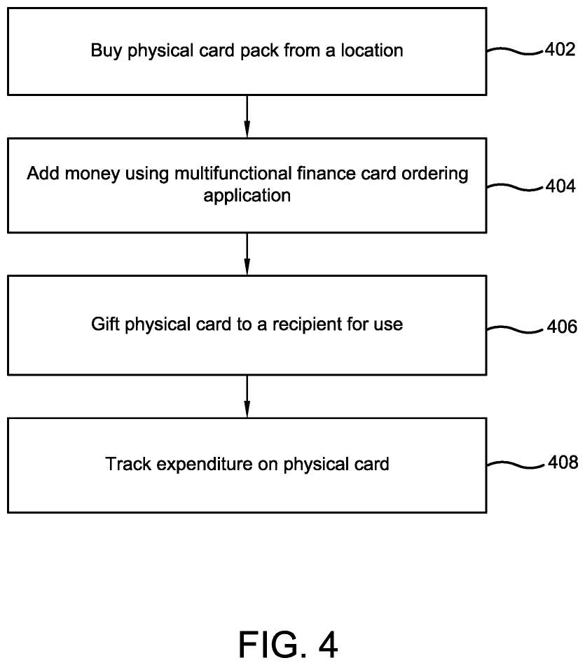

FIG. 4 illustrates a flow diagram depicting a process of adding money to a physical financial card purchased from any location in accordance with the disclosed architecture. In one embodiment of the present invention, the financial cards are sold in packs of various numbers (e.g., 5 to 10 cards) and can be purchased by a user (Step 402). The cards can have different personalized and customized designs to tailor to user needs and preferences. Then, the user can add or transfer money/funds to the purchased cards using the application 102 as described in FIGS. 3A, 3C (Step 404). Recipient information may also be added by the user for associating an intended user, and only the intended user, of the card. After adding money to the card, the user can gift a physical card to the recipient while the server may send a digital copy of the card to the email ID of the recipient (Step 406). Then, the expenditure on the card can be monitored by the user for tracking the card (Step 408).

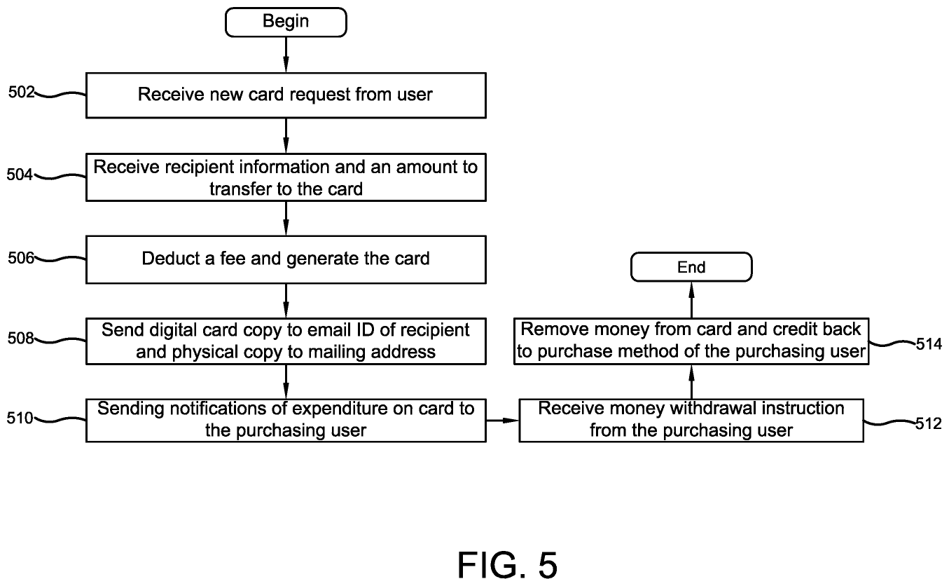

FIG. 5 illustrates a flow diagram depicting process of generating and transacting a financial card and removing cash equivalent from the financial card in accordance with the disclosed architecture. It should be noted that all the steps are performed by a combination of the application 102 and server 104 upon receiving requests from the purchasing user via the software application 102. As shown, initially, the process includes receiving a new card request from a purchasing user (Step 502). Then, receiving intended card user (recipient) information and an amount to be associated with the card (Step 504). When the money is transferred to the card, a convenience fee is deducted for transferring the amount (Step 506). Thereafter, the card is generated, and a physical card is sent to a mailing address of the intended user and a digital copy of the card is sent to the intended user via a messaging application such as email ID, SMS, or MMS (Step 508).

When the card is used for a transaction at a merchant, expenditure notification is sent to the user who purchased the card as a means for tracking expenditure on the card (Step 510). Based on the preference of the purchasing user, the method further includes receiving a money withdrawal instruction or request from the purchaser of the card (Step 512). Upon receiving the request, the server then removes the money from the card and credits that amount back to the purchaser's account from which the money was transferred to the card (Step 514).

FIG. 6 illustrates a flow diagram depicting a process of sending low balance notifications to the user who purchased the financial card in accordance with the disclosed architecture. As shown, initially, the server of the card generation system receives transaction information performed on the financial/gift card (Step 602). The server then transmits the notification containing the balance to the recipient/intended user of the card (Step 604). It should be understood that in some embodiments, the Step 604 can be omitted and no notification can be transmitted to the recipient. A notification is also sent to the user who purchased the card wherein the notification includes merchant information and transaction amount enabling the user to track the transaction (Step 606).

In Step 608, the server determines if there is a low balance on the card. The low balance can be determined when the account is 10% or less of the total value of the card. In such cases, it is determined that the card has a low balance, then, a second notification is sent to the purchasing user for adding money to the card (Step 610). Otherwise, notifications are sent to the user that includes only the current balance of the card (Step 612).

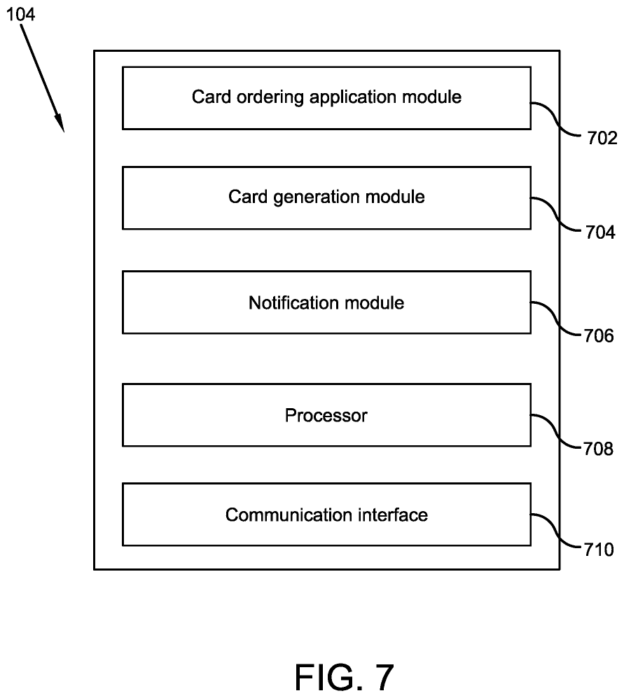

FIG. 7 illustrates a block diagram showing the components of the server 104 used in the present invention in accordance with the disclosed architecture. The server 104 or any part(s) or function(s) thereof can be implemented using hardware, software, or a combination thereof and can be implemented in one or more computer systems or other processing systems. The server 104 includes a card ordering application module 702 that generates a display, GUIs, and web pages on user devices for accessing the functionality provided by the server.

A card generation module 704 is configured to generate physical and digital copies of cards. The physical cards can be generated by card making machines coupled and actuated by the server 104. A notification module 706 is configured to receive notifications of a purchase on generated cards and generate notifications which are transmitted using a communication interface 710 of the server 104.

The server 104 includes one or more processors, such as processor 708. The processor 708 is connected to a communication infrastructure 710 (e.g., a communications bus, cross-over bar, or network). The control logic, when executed by the processor 708, causes the processor 708 to perform the functions of the invention as described herein.

The communications interface 710 enables data to be transferred between server 108 and external devices. Examples of communications interface 710 may include a modem, a network interface (such as an Ethernet card), a communications port, a Personal Computer Memory Card International Association (PCMCIA) slot and card, etc. Software and data transferred via communications interface 710 are in the form of signals which can be electronic, electromagnetic, optical, or other signals capable of being received by communications interface 710.

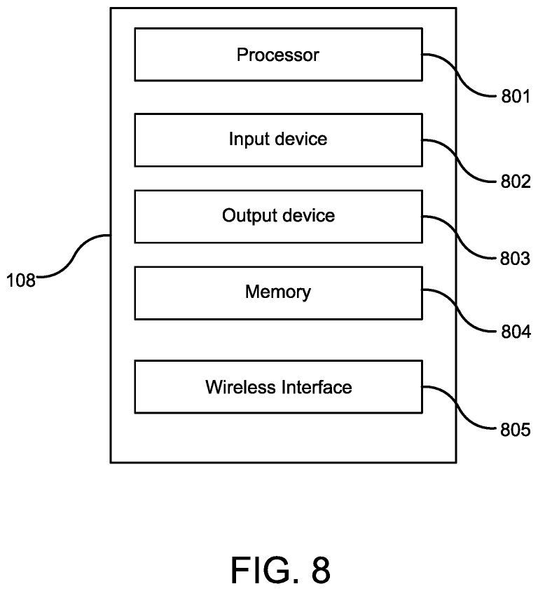

FIG. 8 illustrates an exemplary computing device 108 in which the financial card ordering application 102 of the present disclosure is installed in accordance with the disclosed architecture. The computing device 108 includes several components such as a processor 801 configured to perform one or more functions described herein in accordance with the computer implemented instructions of the application 102. Computing device 108 includes input device(s) 802 such as a mouse, keyboard, touch input device, voice input device, etc. for entering data and information. The device 108 also includes one or more output device(s) 803 such as a monitor, presence-sensitive display, or other display device. The display which can be touch interface acts as both input device 802 and the output device 803. The display can be, for example, a liquid crystal display (LCD), a light emitting diode (LED) display, an organic light emitting diode (OLED) display, an active OLED (AMOLED), Micro-electromechanical systems (MEMS) display, or electronic paper displays. The display can display, for example, various contents (i.e. text, images, videos, icons, and/or symbols, etc.) to the user. The display can include a touch screen, and may receive, for example, a touch, gesture, proximity, or hovering input using an electronic pen or a part of a user's body.

Electronic device 108 includes memory 804 used for storing programs (sequences of instructions) or data (e.g., program state information) on a temporary or permanent basis for use in the computer system. Memory 804 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 801, in combination with one or more of memory 804, input device(s) 802, output device(s) 803 can be utilized to provide users to execute instructions on the application 102. The connection to a network such as the internet is provided by wireless interface 805.

Certain aspects of the present disclosure are described above with reference to block and flow diagrams of systems, methods, apparatuses, and/or computer program products according to various implementations. It should be understood that one or more blocks of the block diagrams and flow diagrams, and combinations of blocks in the block diagrams and the flow diagrams, respectively, can be implemented by computer-executable program instructions.

The computer-executable program instructions of the software application 102 can be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, the computer-readable program code adapted to be executed to implement one or more functions specified in the flow diagram block or blocks.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multipurpose financial card generating system”, “gift card generating system” and “system” are interchangeable and refer to the multipurpose financial card generating system 100 of the present invention. Similarly, as used herein “software application”, “multifunctional finance card ordering application”, and “application”, are interchangeable and refer to the multifunctional finance card ordering application 102 of the present invention. Also, as used herein “gift card”, “multifunctional finance card”, “customized card”, and “card”, are interchangeable and refer to the multifunctional finance card 200 of the present invention

Notwithstanding the forgoing, the multipurpose financial card generating system 100 and the multifunctional finance card ordering application 102 of the present invention can be of any suitable configuration as is known in the art without affecting the overall concept of the invention, provided that it accomplishes the above stated objectives. One of ordinary skill in the art will appreciate that the configuration and specification of the components of the multipurpose financial card generating system 100 and the multifunctional finance card ordering application 102 as shown in the FIGS. are for illustrative purposes only, and that many other configurations of the multipurpose financial card generating system 100 and the multifunctional finance card ordering application 102 are well within the scope of the present disclosure.

Notwithstanding the forgoing, the multifunctional finance card 200 of the present invention can be of any suitable size and configuration as is known in the art without affecting the overall concept of the invention, provided that it accomplishes the above stated objectives. One of ordinary skill in the art will appreciate that the multifunctional finance card 200 as shown in the FIGS. are for illustrative purposes only, and that many other sizes and shapes of the multifunctional finance card 200 are well within the scope of the present disclosure. Although the dimensions of the multifunctional finance card 200 are important design parameters for user convenience, the multifunctional finance card 200 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of generating and transacting a financial card, the method comprising the steps of:
receiving a financial card request from a purchaser;
receiving intended card user recipient information;
assigning a monetary amount to be associated with said financial card;
transferring said monetary amount to said financial card from said purchaser's transferor account;
deducting a convenience fee from said transferor account;
generating said financial card;
mailing said financial card to said recipient;
sending a digital copy of said financial card to said purchaser;
using said financial card for a transaction at a merchant;
notifying said purchaser of said transaction;
tracking said transaction by said purchaser;
receiving a money withdrawal instruction from said purchaser of said financial card; and
removing said money withdrawal from said financial card.

2. The method of claim 1, wherein said digital copy of said financial card includes a messaging application selected from a group consisting of an email ID, an SMS, and an MMS.

3. The method of claim 1 further comprising a step of crediting said money withdrawal back to said transferor account.

4. The method of claim 1 further comprising a step of sending a first low balance notification to said purchaser of said financial card.

5. The method of claim 4, wherein said low balance is 10% or less than said monetary amount.

6. The method of claim 5 further comprising a step of sending a second low balance notification to said purchaser of said financial card.

7. The method of claim 6 further comprising a step of assigning another monetary amount to be associated with said financial card, and a step of transferring said another monetary amount to said financial card from said purchaser's transferor account.

8. The method of claim 7, wherein said notifying said purchaser of said transaction includes a transaction amount and an identification of said merchant.

9. The method of claim 8, wherein said financial card includes a front surface including a selectable theme-based design and a selectable message.

10. A method of generating and transacting a financial card, the method comprising the steps of:
receiving a financial card request from a purchaser;
receiving intended card user recipient information;
assigning a monetary amount to be associated with said financial card;
transferring said monetary amount to said financial card from said purchaser's transferor account;
deducting a convenience fee from said transferor account;
generating said financial card;
mailing said financial card to said recipient;
sending a digital copy of said financial card to said purchaser;
using said financial card for a transaction at a merchant;
notifying said purchaser of said transaction;
tracking said transaction by said purchaser;
sending at least a first low balance notification to said purchaser of said financial card, wherein said low balance is 10% or less than said monetary amount;
assigning another monetary amount to be associated with said financial card; and
transferring said another monetary amount to said financial card from said purchaser's transferor account.

11. The method of claim 10 further comprising a step of receiving a money withdrawal instruction from said purchaser of said financial card, and a step of removing said money withdrawal from said financial card.

12. The method of claim 10, wherein said digital copy of said financial card includes a messaging application selected from a group consisting of an email ID, an SMS, and an MIMS.

13. The method of claim 11 further comprising a step of crediting said money withdrawal back to said transferor account.

14. The method of claim 10, wherein said notifying said purchaser of said transaction includes a transaction amount and an identification of said merchant.

15. The method of claim 10, wherein said financial card includes a front surface including a selectable theme-based design and a selectable message.

16. A method of generating and transacting a financial card, the method comprising the steps of:
receiving a financial card request from a purchaser;
receiving intended card user recipient information;
selecting a theme-based design and a selectable message for printing on a front surface of said financial card;
assigning a monetary amount to be associated with said financial card;
transferring said monetary amount to said financial card from said purchaser's transferor account;
generating said financial card;
mailing said financial card to said recipient;
using said financial card for a transaction at a merchant;
notifying said purchaser of said transaction;
tracking said transaction by said purchaser;
sending at least a first low balance notification to said purchaser of said financial card;
assigning another monetary amount to be associated with said financial card; and
transferring said another monetary amount to said financial card from said purchaser's transferor account.

17. The method of claim 16 further comprising a step of receiving a money withdrawal instruction from said purchaser of said financial card, and a step of removing said money withdrawal from said financial card.

18. The method of claim 16 further comprising a step of sending a digital copy of said financial card to said purchaser, wherein said digital copy of said financial card includes a messaging application selected from a group consisting of an email ID, an SMS, and an MMS.

19. The method of claim 17 further comprising a step of crediting said money withdrawal back to said transferor account.

20. The method of claim 16, wherein said notifying said purchaser of said transaction includes a transaction amount and an identification of said merchant.
